(19) United States
(12) Patent Application Publication
(10) Pub. No.: US 2023/0245791 A1
(43) Pub. Date: Aug. 3, 2023

(54) Next-Gen Nuclear Reactors with Molten Lithium as Coolant and Secondary Fuel

(71) Applicants: Shijun Sun, Redmond, WA (US); Daniel Sun, Redmond, WA (US)

(72) Inventors: Shijun Sun, Redmond, WA (US); Daniel Sun, Redmond, WA (US)

(21) Appl. No.: 17/649,353

(22) Filed: Jan. 29, 2022

(51) Int. Cl. G21B 1/01; G21B 1/11

(52) U.S. Cl. CPC G21B 1/01; G21B 1/11

(57) ABSTRACT

An introduction of nuclear fusion into conventionally fission-based nuclear reactors. Particularly, coolant in the reactor serves as the secondary fuel that absorbs neutrons from the fission core, and releases energy through fusion reactions. Molten Lithium is the preferred coolant in the invention, as it produces Helium gas through the neutron-Lithium fusion without leaving any radioactive or chemical impact to the environment. A Helium pressure controller is also introduced in the system to manage the Helium gas produced by nuclear reactions of the secondary fuel. Lithium Chloride (LiCl) is proposed as the secondary coolant in lieu of the commonly used molten salt in order to achieve higher power production efficiency. A reactor based on the proposed system requires less space than a conventional reactor of the same power. It is a better choice than conventional nuclear reactors when space is a key constraint, for example, on a container ship.

### BACKGROUND

As a continuous effort to battle global warming, the nuclear energy industry has been looking into various options for the next generation technologies towards more sustainable, reliable, economical, and safe solutions. Meanwhile, there is an urgent need globally to replace the aging fleet of nuclear reactors, especially after the Fukushima Daiichi accident in 2011.

Prior Art #1

Among the proposed solutions so far, Sodium Fast Reactor (SFR) has become one of the options drawing close attention from the industry as well as financial support from the US Congress. In a nutshell, molten sodium is applied as the coolant in an SFR to replace other traditional coolant options, such as light water, heavy water, etc. When combined with molten salt as a secondary coolant and the heat source for steam based turbine generators, it has the potential to revolutionize the nuclear energy industry through improved power efficiency and flexibility.

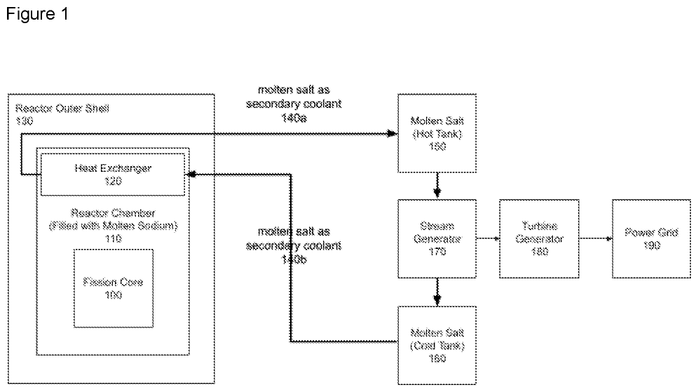

As in FIG. 1, an SFR has a fission core (100) in a reactor chamber (110) filled with molten sodium as coolant. The coolant picks up the heat produced by the fission core. The heat of the coolant can then be picked up by the secondary coolant (molten salt) through a heat exchanger (120). The hot molten salt (140a) is passed to and stored in a hot tank (150). When needed, the hot molten salt can be pumped to a stream generator (170) to drive turbine generators (180), which then passes the produced electricity to the power grid (190). The colder molten salt (140b) is passed back from the cold tank (160) to the heat exchanger in the reactor to continue picking up more heat. The commonly used molten salt is a mixer of sodium nitrate (60%) and potassium nitrate (40%). There is also typically an outer shell (130) to the reactor with purposes of additional protection to the reactor core, to provide mitigation options to any accidents, e.g. to prevent contact with air or water in case of any leak of the flammable sodium coolant from the reactor chamber.

Although there are other similar options using various coolants, e.g. molten lead, high pressure water, or high pressure gas, the molten sodium is representative enough and hence it is referred to as the primary prior art in this invention.

Prior Art #2

Although not directly related to conventional nuclear reactors, plasma-based Fusion technologies under development in the past decades are relevant in terms of fundamental physics. Therefore, it is listed here as context and another prior art. No matter what the plasma confinement options are, e.g. magnetic or laser, the basic thermal nuclear reactions are all about combining smaller elements into ones with higher binding energies.

Since the invention is based on the Lithium based nuclear reactions, the following is called out as a typical fusion option related to Lithium.

Lithium-6+Deuterium→2×Helium-4+22.37 MeV (1)

While hoping the industry's effort on the fusion technologies will eventually be able to benefit humanity in the long run, the method in this invention is however not based on the concept in (1), and will not use Deuterium as nuclear fuel in the process.

### SUMMARY

This invention introduces the nuclear fusion process into the conventionally fission-based reactors. It's an evolution of the current nuclear reactor designs rather than a total revolution based on fusion-only based plasma technologies.

Particularly, new coolant is introduced in the reactor to serve as the secondary fuel that absorbs neutrons from the fission core, and releases secondary power through fusion reactions. Molten Lithium is considered the preferred coolant in the invention, as it produces Helium gas through the neutron-Lithium fusion without leaving any radioactive or chemical impact to the environment.

A Helium pressure controller is also introduced in the system to manage the Helium gas produced by nuclear fusion reactions using the secondary fuel. The pressure controller keeps gas pressure balance between the reactor chamber and the external environment by either releasing Helium gas from the reactor chamber or injecting Helium gas into the reactor chamber. It also manages the pressure in the outer prediction shell space.

To leverage the higher operating temperature of the new coolant, Lithium Chloride (LiCl) is proposed as the secondary coolant in lieu of the commonly used molten salt in order to achieve higher operating temperature of the secondary coolant and hence higher power production efficiency. It is expected the proposed system could bring reactor power efficiency beyond 50%.

A reactor based on the proposed system requires less space than a conventional reactor of the same power capacity. It is a better choice when space is a key constraint, for example, on a container ship.

### BRIEF DESCRIPTION OF DRAWINGS

1. FIG. 1 is an illustration of the basic structure of a Sodium Fast Reactor (SFR) as a prior art.

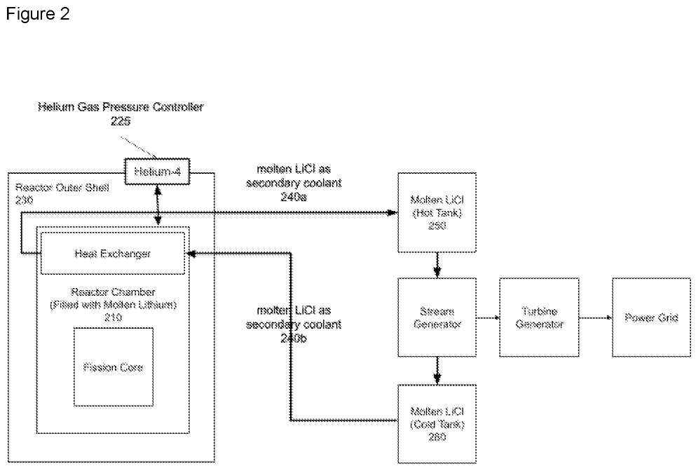

2. FIG. 2 is an illustration of the reactor structure with molten Lithium as coolant, an explicit Helium based pressure controller, and Lithium Chloride (LiCl) as the secondary coolant. It highlights the differences relative to the prior art, so does not label the common components in FIG. 1.

### DETAILED DESCRIPTIONS

### The Physics of Lithium

Naturally occurring Lithium is composed of two stable isotopes, Lithium-6 and Lithium-7, with Lithium-7 being more abundant (92.5% natural abundance).

The following is a comparison of some basic physical properties between Lithium and sodium, which is the primary coolant used in Prior Art #1.
Melt Point (Celsius)
   Sodium: 97.8
   Lithium: 180.5
Boiling Point (Celsius)
   Sodium: 882.9
   Lithium: 1330
Density when liquid (g/cm\hat{ }3)
   Sodium: 0.927
   Lithium: 0.512
Heat Capacity in J/(kg*K)
   Sodium: 1227
   Lithium: 3551
Heat Capacity in J/(m\hat{ }3*K)
   Sodium: 1.138×10\hat{ }6
   Lithium: 1.818×10\hat{ }6

Based on the physical properties above, there are several immediate benefits of using molten Lithium as coolant in a reactor.
Lithium has a much wider temperature range when in liquid state, i.e. 1150 Celsius vs. 785 Celsius (sodium). It allows more flexibility in the reactor temperature control, with a huge operation and safety buffer range before the boiling point.
Lithium is much lighter in density. It requires less force to move it around when circulating within the reactor chamber.
Lithium has much higher heat capacity in either unit mass or unit volume. It can hold more heat than the sodium within the same space while applying less gravity load on the core reactor.

Next, looking into deeper aspects of the physics, neutrons created by the fission reactions in the Fission Core can trigger the following reactions.

Lithium-7+neutron→Lithium-8+2.03 Mev (2)

Lithium-8→Beryllium-8+electron+electron-antineutrino+15.49 Mev (3)

Beryllium-8→2×Helium-4+0.09 Mev (4)

Overall, it takes one neutron to turn one Lithium-7 into 2 Helium-4 plus an electron and an antineutrino, with a total energy of 17.61 Mev released.
The reaction in (2) is technically a fusion step. So, this will allow fusion reactions as a secondary power production in parallel to the main fission reactions.
The neutron cross section for (2) is quite small, so the expectation is that the fusion process will be a slow process. However, if there is a large volume of Lithium (as reactor coolant), the possibility of fusion would be improved proportionally.
The half life of Lithium-8 is less than a second, so statistically the beta decay in (3) will complete in a number of seconds.
The half life of Beryllium-8 is in the order of 10\hat{ }-17 seconds, so (4) would happen instantaneously.

There is no radioactive element (or nuclear waste) as the final outcome, since Helium-4 is a very stable nucleus. And, there is no chemically active element either, with Helium-4 gas being a noble gas.

What about the other isotope of Lithium, since Lithium-6 is still 7.5% of the element in nature if not separated purposely. The following is the fusion reaction between Lithium-6 and neutrons.

Lithium-6+neutron→Lithium-7+7.25 MeV (5)

It basically turns Lithium-6 into Lithium-7 with a significant energy release, and the Lithium-7 will then join the same reaction chain as described in (2)-(4).

In general, the Lithium coolant can slowly clean up neutrons from the fission reactions and produce extra energies as the secondary fuel, and release Helium-4 gas.

### Proposed System

The proposed system in this invention is largely the same as illustrated in FIG. 1, with three major exceptions as illustrated in FIG. 2.
The reactor chamber is now filled with molten Lithium (210) in the place of the coolant.
There is a Helium Gas Pressure Controller (225) connecting the main reactor chamber and the outside environment.
The secondary coolant is Lithium Chloride (LiCl) in the proposed system.

The molten Lithium in the reactor chamber will get most heat from the fossil core, and then produce further energy when absorbing neutrons produced by the fission core.

The reactor can operate in a temperature range between 650 to 1000 Celsius with enough safety margin. It allows the secondary coolant to operate at up to 1000 Celsius, which is way beyond what a sodium based reactor could achieve. The high temperature of the secondary coolant can lead to a power production efficiency beyond 50%, so will be a huge jump in the energy industry.

To allow the secondary coolant to benefit from the higher temperature range of the reactor, there is a need for a new material that is stable and has a higher boiling point. In the proposed system, Lithium Chloride (LiCl) is a replacement of the typically molten salt consisting of sodium nitrate and potassium nitrate. Lithium Chloride has a higher boiling point of 1383 Celsius, a melting point of 610 Celsius, a lower density (1.02 g/cm\hat{ }3), and a similar heat capacity per mass (1132 J/Kg*K).

As illustrated in FIG. 2, Lithium Chloride (LiCl) is the alternative to molten salt in the prior art #1, represented as the secondary coolant going out of the reactor (240a), in the hot tank (250), in the cold tank (260), and as the secondary coolant going into the reactor (240b).

Based on laws of thermodynamics, the efficiency of an ideal heat engine is defined as

Efficiency=(T_high−T_low)/T_high (6)

where T_high is the temperature of the heat source (e.g. the hot tank in an SFR) measured in Kelvin, T_low is the temperature of the cold sink in Kelvin. Given a fixed T_low, the higher the T_high, the higher the efficiency. For example, when T_low is 200 Celsius (471 Kelvin), if T_high changes from 500 Celsius (771 Kelvin) to 800 Celsius (1071 Kelvin), the heat engine efficiency would change from 39% to 56%, which is a significant improvement.

Since Helium gas will be released as the residuals of the secondary/fusion reactions, the Helium Gas Pressure Controller is responsible for balancing the relative gas pressure between the main chamber and the outside environment.
The gas pressure within the chamber should be a bit higher than the outside environment to make sure no external elements (e.g. oxygen, water molecules) can enter the system.
When necessary, the pressure controller should inject Helium gas to the chamber to make sure the chamber gas pressure is always high enough to protect the reactor.
The pressure controller should make sure the chamber gas pressure is not too much beyond the external environment, by releasing Helium gas as needed.

The space between the reactor chamber and the outer protection shell (230) should be filled with noble gas as well, e.g. Helium-4. It should always have a pressure slightly higher than the gas pressure in the reactor chamber, therefore also higher than the external environment as well. The same Helium Gas Pressure Controller can be used to balance among all three pressures: external environment, reactor chamber, and outer protection shell space. The outer protection shell space should always have the highest pressure, followed by the reactor chamber, then the external environment.

The Lithium fusion action is a slower process than the reactions in the fission core. When the fission fuel burns out and needs to be replaced, e.g. in every ˜24 months, additional Lithium coolant can also be added based on its consumption. There is no need to replace the remaining Lithium.

Due to the additional power produced by the Lithium fusion process, and the higher heat capacity of Lithium, a reactor with specific power capacity can have smaller size than conventional reactors or the prior art #1. Therefore, a Lithium based reactor can potentially be a better option whenever space is a constraint, for example, on a vessel, with the expectation that future container ship fleets should not burn fossil fuels.

1. A nuclear reactor with a fission core and the coolant as secondary fuel to allow neutron based fusion.

2. The coolant and secondary fuel in claim #1 is molten Lithium.

3. The Lithium in claim #2 is Lithium-7.

4. The Lithium in claim #2 is Lithium-6.

5. The Lithium in claim #2 is a mixer of Lithium-6 and Lithium-7.

6. The coolant and secondary fuel in claim #1 is a mixer of molten Lithium and other molten metals, e.g. sodium.

7. The molten Lithium in claim #2 operate in a temperature range between 650 and 1000 Celsius.

8. A nuclear reactor with a Helium-4 based pressure controller connected to the main reactor chamber.

9. The pressure controller in claim #8 balances the pressure between the reactor chamber and the external environment by releasing Helium gas from the chamber.

10. The pressure controller in claim #8 balances the gas pressure between the reactor chamber and the external environment by injecting Helium gas to the chamber.

11. The pressure controller in claim #8 balances the gas pressure between the reactor chamber and the external environment by keeping the reactor chamber pressure always a bit higher than that of the external environment.

12. The pressure controller in claim #8 balances the gas pressure among the outer protection shell space and the reactor chamber by keeping the outer protection shell space pressure always a bit higher than that of the reactor chamber.

13. The nuclear reactor as in claim #1 can be installed in a constrained space.

14. The constrained space in claim #13 is a vessel, e.g. a container ship.

15. A nuclear reactor with Lithium Chloride as the secondary coolant to bring heat from the reactor and pass the energy to the steam generator.

16. The secondary coolant as in claim #15 operates at a temperature above 800 Celsius when it's stored in the hot tank and when it's applied for steam generation.
